(19) United States
(12) Patent Application Publication
(10) Pub. No.: US 2020/0130856 A1
(43) Pub. Date: Apr. 30, 2020

(54) NACELLE INLET AND SYSTEM AND METHOD FOR MAKING SAME

(71) Applicant: SPIRIT AEROSYSTEMS, INC., Wichita, KS (US)

(72) Inventor: Randall Ray West, Wichita, KS (US)

(73) Assignee: SPIRIT AEROSYSTEMS, INC., WICHITA, KS (US)

(21) Appl. No.: 16/169,612

(22) Filed: Oct. 24, 2018

(51) Int. Cl. B64D 33/02; B64D 29/00; F02C 7/045

(52) U.S. Cl. CPC B64D 33/02; B64D 29/00; F02C 7/045; F05D 2230/233; F05D 2230/234; B33Y 10/00; F05D 2230/31; F05D 2230/10; B64D 2033/0286; B64D 2033/0226; B64D 2033/0206; F05D 2230/239

(57) ABSTRACT

An inlet for a nacelle and an AM system and method for manufacturing the inlet having fewer discontinuities on the exterior surface to achieve a smoother flow over the inlet. The inlet includes an annular lip-cowl and a supporting framework. The AM system includes a support structure providing a form, and AM heads for depositing materials onto the form, with the materials subsequently hardening to become the lip-cowl. The support structure may have an upright or inverted orientation, is rotatable, and may be tiltable. Components may protrude from the form to be incorporated into the lip-cowl. The AM heads are mounted on moveable arms and are computer-controlled to deposit the material onto the form, and may be moveable along a radial axis to accommodate an asymmetrical portion of the form. The AM system may further include one or more machining heads for subtractively machining the deposited material.

### FIELD

The present invention relates to systems and methods for manufacturing body components of aircraft and other vehicles, and more particularly, embodiments concern a nacelle inlet and an additive manufacturing system for manufacturing the nacelle inlet having fewer discontinuities so as to achieve a smoother flow of fluid over the surfaces of the inlet.

### BACKGROUND

Referring to FIGS. 1 (PRIOR ART) and 2 (PRIOR ART), an aircraft engine 50 is housed within a nacelle 52 which includes an inlet 54 and a body 56. The inlet 54 includes a lip 58, a cowl 60, one or more bulkheads (e.g., fore and aft) 62 and an acoustic panel or inner barrel 64. The lip 58 and cowl 60 are fabricated as discrete components and then subsequently fastened together, which can result in discontinuities such as fasteners, seams, and gaps. In critical areas, these discontinuities can disrupt or “trip” the boundary layer laminar flow and create separation resulting in turbulence and increased drag.

Attempts have been made to reduce the number of such discontinuities. These include utilizing thick material which is formed (forced) onto expensive tooling and then heavily machined to reduce the material thickness to the required structural gauges, which results in substantial waste and increases overall cost. Further, while this may eliminate the need for fastened stiffeners by including the stiffener height within the skin material thickness, it again increases waste which further increases overall cost.

This background discussion is intended to provide information related to the present invention which is not necessarily prior art.

### SUMMARY

Embodiments of the present invention overcome the above-described and other problems and limitations in the prior art by providing a nacelle inlet and an additive manufacturing (AM) system and method for manufacturing the nacelle inlet having fewer discontinuities so as to achieve a smoother flow of fluid over the surfaces of the inlet.

In a first embodiment, an inlet is provided for a nacelle (for, e.g., an aircraft), with the inlet including an annular lip-cowl and a framework. The annular lip-cowl may include a lip portion and a cowl portion and may have an interior surface and an exterior surface, and the lip-cowl may have no protruding fastener heads and no annularly-extending joints on the exterior surface. The framework may be associated with the interior surface of the lip-cowl and may be configured to physically support the lip-cowl.

Various implementations of the first embodiment may include any one or more of the following features. The framework may include an annular shell, and the shell may be a monolithic structure or may include a plurality of panels which are joined together. The shell may include an inner component and an outer component which are joined together. The shell may include a plurality of stiffener elements, one or more bulkheads, and/or a plurality of longitudinal ribs. The lip-cowl may be a monolithic structure or may include a plurality of segments which are joined together. The framework may be fused or mechanically attached to the interior surface of the lip-cowl.

In a second embodiment, an additive manufacturing (AM) system is provided for manufacturing an annular lip-cowl for an inlet of a nacelle (for, e.g., an aircraft). The annular lip-cowl may include a lip portion and a cowl portion and may have an interior surface and an exterior surface, and the lip-cowl may have no protruding fastener heads and no annularly-extending joints on the exterior surface. The AM system may include a temporary support structure and an AM head. The temporary support structure may be configured as a form. The AM head may be configured to deposit a material onto the form, wherein the material subsequently hardens to become at least the lip portion and the cowl portion of the lip-cowl.

Various implementations of the second embodiment may include any one or more of the following features. The temporary support structure may have an upright orientation with the lip portion located above the cowl portion, and may have a shelf positioned on the exterior surface of the cowl portion and configured to receive and support an initial deposition of the material. The support structure having an inverted orientation with the lip portion located below the cowl portion, and may include a separate support scaffolding for physically supporting the lip portion of the lip-cowl. The support structure may be rotatable about a vertical axis, wherein the support structure is rotated about the vertical axis as the AM head deposits the material onto the form. The support structure may be tiltable about a horizontal axis, wherein the support structure is rotated about the horizontal axis as the AM head deposits the material onto the form. The AM system may further include a plurality of build supports projecting from the form and configured to support and maintain the material deposited onto the form by the AM head. The AM system may further include a plurality of stiffener elements projecting from the form so as to be integrated into the lip-cowl by the material deposited onto the form by the AM head. The AM system may further include a surface configured to minimize fusing of the material to the form, or the AM system may further include a sacrificial layer positioned over the form and configured to temporarily support one or more stiffener elements.

The AM head may be mounted on a moveable arm and may be computer-controlled to move over the form and deposit the material. The AM head may be moveable along a radial axis relative to the form and a vertical axis relative to the form, wherein the additive manufacturing head is moveable along the radial axis to accommodate an asymmetrical portion of the form. The AM system may further include a plurality of additional AM heads configured to simultaneously deposit a plurality of adjacent layers of the material in a wide band. The AM head may deposit the material circumferentially as the form is rotated and vertically when the form is stationary. The AM head may deposit a first type of the material onto a first area of the form and a second type of the material onto a second area of the form. The AM system may further include a machining head configured to machine an area of the material deposited onto the form by the AM head.

In a third embodiment, a method of manufacturing an annular lip-cowl for an inlet of a nacelle (for, e.g., an aircraft), with the lip-cowl including a lip portion and a cowl portion and having an interior surface and an exterior surface, may include the following steps. A first portion of the lip-cowl may be manufactured using a first manufacturing technique. The first portion of the lip-cowl may be positioned on a temporary support structure configured as a form. A second portion of the lip-cowl may be manufactured using an AM technique to deposit a material onto the form and over at least an area of the first portion of the lip-cowl positioned on the support structure, wherein the material subsequently hardens so that the first and second portions of the lip-cowl are connected.

Various implementations of the third embodiment may include any one or more of the following features. The first portion may be the cowl portion and the second portion may be the lip portion. The first manufacturing technique may be a spin-forming technique or a stretch-forming technique. The first portion may include a scarf at an interface between the first portion and the second portion so that the connection between the first and second portions includes a scarf joint. The first portion may include a connection structure at an interface between the first portion and the second portion so that the connection between the first and second portions includes the connection structure. The first portion may be manufactured from a different material than the second portion. The temporary support structure may have an upright orientation with the lip portion located above the cowl portion. The support structure may have an inverted orientation with the lip portion located below the cowl portion. The support structure may be rotatable about a vertical axis, and the method may further include rotating the support structure about the vertical axis as an additive manufacturing head deposits the material onto the form to manufacture the second portion. The support structure may be tiltable about a horizontal axis, and the method may include tilting the support structure about the horizontal axis as the additive manufacturing head deposits the material onto the form to manufacture the second portion.

The method may further include manufacturing a third portion of the lip-cowl; positioning the third portion of the lip-cowl on the form, and manufacturing the second portion of the lip-cowl using the additive manufacturing technique to deposit the material onto the form and over at least an area of the third portion of the lip-cowl positioned on the form, wherein the material subsequently hardens so that the first and third portions of the lip-cowl are connected. The third portion of the lip-cowl may be one or more stiffener elements. The third portion of the lip-cowl may be one or more connection elements positioned at an interface between the first and second portions of the lip-cowl. The method may further include machining an area of the material deposited onto the form by the additive manufacturing head.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 (PRIOR ART) is a fragmentary cross-sectional side elevation view of an exemplary prior art nacelle housing an aircraft engine;

FIG. 2 (PRIOR ART) is a cross-sectional side elevation view of an inlet portion of the exemplary prior art nacelle of FIG. 1 (PRIOR ART);

FIG. 3 is a cross-sectional side perspective view of an embodiment of an inlet including a lip-cowl component and a framework component constructed in accordance with an embodiment of the present invention;

FIG. 4 is a cross-sectional side elevation view of the inlet of FIG. 3;

FIG. 5A is an exploded isometric view of the inlet of FIG. 3 showing a shell implementation of the framework component;

FIG. 5B is an exploded isometric view of the inlet of FIG. 3 showing a lattice implementation of the framework component;

FIG. 6 is a cross-sectional side elevation view of an implementation of the framework component having fully integrated flanges;

FIG. 7 is a cross-sectional side elevation view of an implementation of the framework component having separately manufactured and subsequently integrated flanges;

FIG. 8 is a cross-sectional side elevation view of an implementation of the framework component having separate panels and integrated formed shapes;

FIG. 9 is a cross-sectional side elevation view of an implementation of the framework component having attached formed shapes;

FIG. 10 is a cross-sectional side elevation view of an implementation of the framework component having inner and outer skins and stiffeners integrated into the inner skin;

FIG. 11 is a cross-sectional side elevation view of an implementation of the framework component having inner and outer skins and stiffeners integrated into both the inner and outer skins, wherein respective inner and outer stiffeners do not contact;

FIG. 12 is a cross-sectional side elevation view of an implementation of the framework component having inner and outer skins and stiffeners integrated into both the inner and outer skins, wherein respective inner and outer stiffeners do contact;

FIG. 13 is a cross-sectional side elevation view of an implementation of the lip-cowl component having multiple segments with a joint located in a first example position;

FIG. 14 is a cross-sectional side elevation view of an implementation of the lip-cowl component having multiple segments with the joint located in a second example position;

FIG. 15 is a cross-sectional side elevation view of an implementation of the lip-cowl component having multiple segments with interposed structural components;

FIG. 16 is a cross-sectional side elevation view of an implementation of the lip-cowl component having multiple segments with integrated or attached structural components;

FIG. 17 is a cross-sectional side elevation view of an implementation of the lip-cowl component integrated with a shell of the framework component;

FIG. 18 is a cross-sectional side elevation view of an implementation of the lip-cowl component having integrated sandwich panel elements;

FIG. 19A is a cross-sectional elevation view of an embodiment of an additive manufacturing system for manufacturing the lip-cowl component in an upright orientation;

FIG. 19B is an isometric view of a support structure component of the system of FIG. 19A;

FIG. 19C is a fragmentary cross-sectional elevation view of a stiffening structure integrated into the lip-cowl component by a material deposited by the system of FIG. 19A;

FIG. 19D is a fragmentary cross-sectional elevation view of a shelf structure for supporting the material deposited by the system of FIG. 19A;

FIG. 20 is a cross-sectional elevation view of an implementation of the support structure component of the additive manufacturing system of FIG. 19A having a sacrificial layer;

FIG. 21A is a fragmentary cross-sectional elevation view of an implementation of the additive manufacturing system having multiple additive manufacturing heads depositing single continuous bands of material;

FIG. 21B is a side elevation view of a lip-cowl produced by the system of FIG. 21A showing the bands of material;

FIG. 22A is a fragmentary cross-sectional elevation view of an implementation of the additive manufacturing system having multiple additive manufacturing heads depositing multiple layered bands of material;

FIG. 22B is a side elevation view of a lip-cowl produced by the system of FIG. 22A showing the multiple-layered bands of material;

FIG. 23A is a fragmentary cross-sectional elevation view of an implementation of the additive manufacturing system for manufacturing the lip-cowl component in an inverted orientation;

FIG. 23B is an isometric view of a support structure component of the system of FIG. 23A;

FIG. 24A is a cross-sectional elevation view of the support structure component of the system of FIG. 23A having an additional tilt axis and tilted in a first direction;

FIG. 24B is a cross-sectional elevation view of the support structure component of the system of FIG. 23A having the additional tilt axis and tilted in a second direction;

FIG. 25A is a fragmentary cross-sectional elevation view of an implementation of the additive manufacturing system configured for vertical deposition of the material;

FIG. 25B is a plan view of an implementation of the system of FIG. 25A having multiple additive manufacturing head components;

FIG. 26A is a fragmentary cross-sectional elevation view of an implementation of the additive manufacturing system configured for diagonal deposition;

FIG. 26B is a plan view of an implementation of the system of FIG. 26A having multiple additive manufacturing head components;

FIG. 27A is a fragmentary cross-sectional elevation view of an implementation of the additive manufacturing system wherein the support structure component is oriented and rotated vertically;

FIG. 27B is a plan view of an implementation of the system of FIG. 27A having a single additive manufacturing head component;

FIG. 28A is a fragmentary cross-sectional elevation view of an implementation of the lip-cowl component constructed with two or more materials having different properties;

FIG. 28B is a fragmentary cross-sectional elevation view of a portion of the lip-cowl component of FIG. 28A showing an integrated stiffening structure component;

FIG. 29 is an isometric view of the framework component having high-relief features;

FIG. 30 is a cross-sectional side elevation view of an example framework component of FIG. 29;

FIG. 31 is an embodiment of a flowchart of a method of manufacturing a hybrid lip-cowl component; and

FIG. 32 is an exploded isometric view of the inlet wherein the framework component is integrated with an engine.

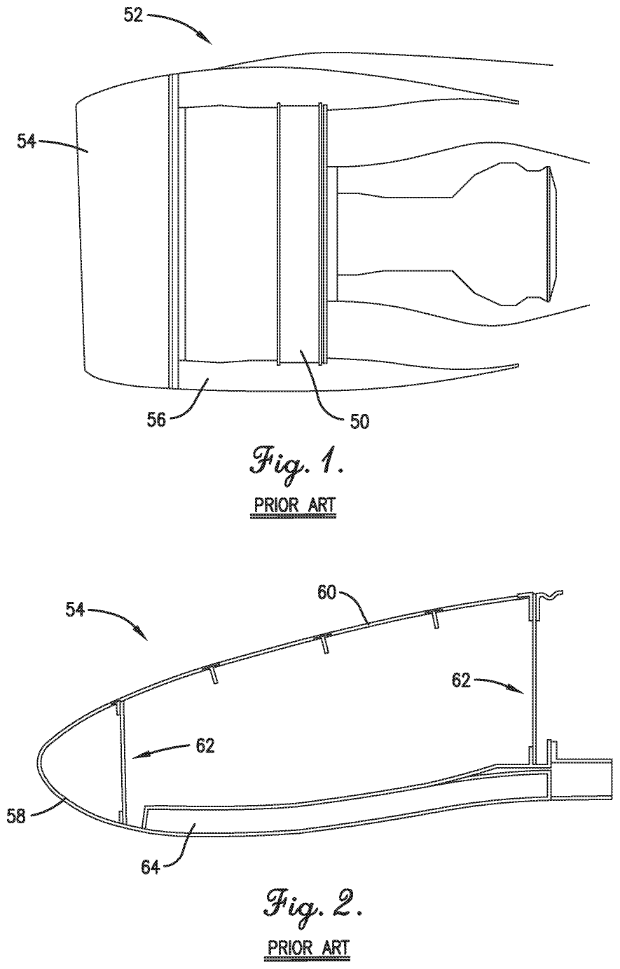

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for manufacturing body components of vehicles. More particularly, embodiments provide a system and method for manufacturing a body component of a vehicle (e.g., aircraft or watercraft) to achieve a smoother flow of fluid (e.g., air or water) over the body component. One implementation provides a nacelle inlet and an AM system and method for manufacturing the nacelle inlet having fewer discontinuities so as to achieve a larger area of laminar flow of air over the surfaces of the inlet and thereby reduces drag. This is accomplished, at least in part, by reducing the exposure of fasteners to the airflow and reducing the use of joints (i.e., steps or gaps) between components, which facilitates maintaining boundary layer laminar flow and avoids separation which could otherwise lead to increased drag. Additionally, the AM system and method for manufacturing the inlet advantageously allows for creating an integrated structure with less material waste and fewer tooling requirements. Although described herein in the example context of manufacturing inlets for aircraft nacelles, the present technology may be used in other contexts to manufacture other components that are located in critical boundary layer flow areas (e.g., wing/airfoil leading edges) and components that are not located in critical flow areas (e.g., nacelle fan cowls, thrust reverser components, primary exhaust nozzle/plug, and pylon fairings).

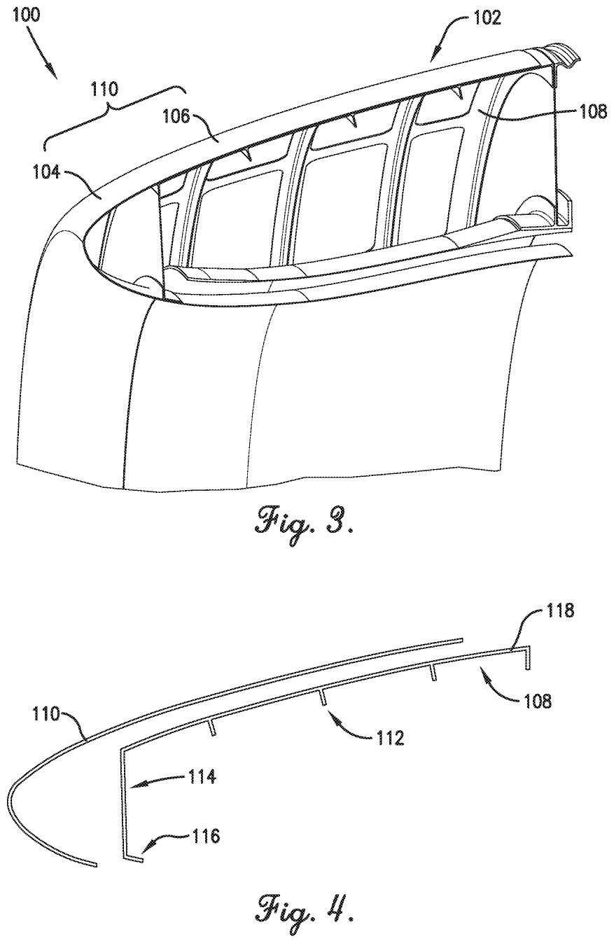

Referring to FIGS. 3, 4, 5A, and 5B an embodiment of an inlet 100 for a nacelle 102 may include a lip 104, a cowl 106, and an internal framework 108. The lip 104 and cowl 106 may be fabricated as or otherwise integrated into a unitary “lip-cowl” structure 110, and the lip-cowl 110 may be further joined or otherwise integrated with the internal framework 108 to provide support and compartmentalization as desired or needed. The inlet 100 may further include internal stiffening components 112, one or more internal bulkheads 114, one or more internal angle components 116, and/or other components as desired or needed.

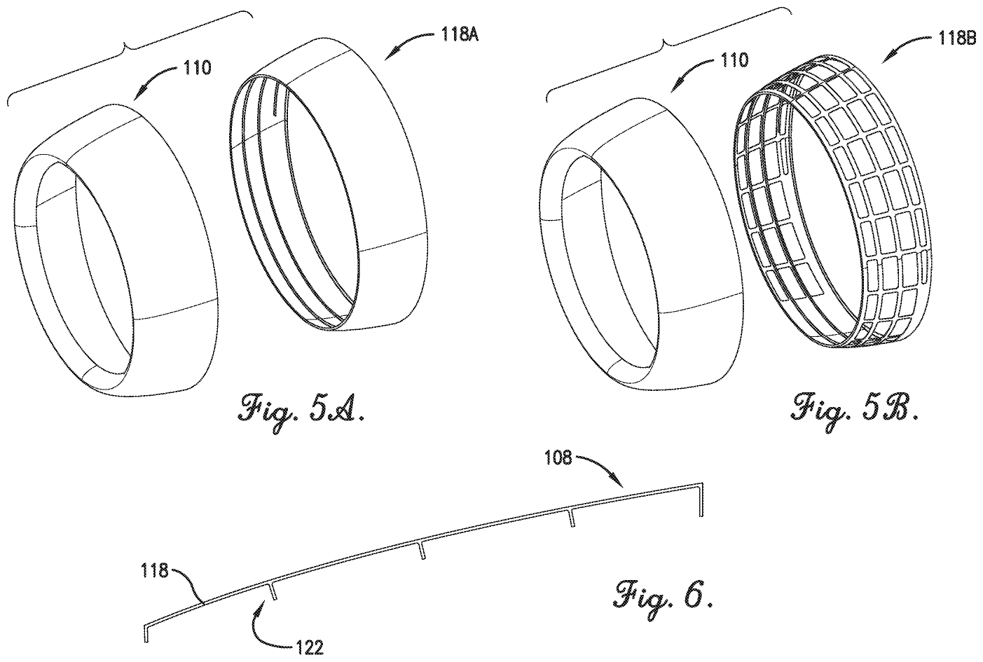

The framework 108 may include a shell 118 which spans from a forward or first location to an aft or second location relative to a centerline of an engine, and which extends annularly substantially 360 degrees around an external aero-contour of the inlet 100. In one implementation, seen in FIG. 5A, the shell 118A may be substantially solid (having few or no openings), while in another implementation, seen in FIG. 5B, the shell 118B may include a larger number of openings which may impart a lattice-like appearance to the framework. The framework 108 may be manufactured using substantially any suitable method depending on performance objectives and constraints of the design space.

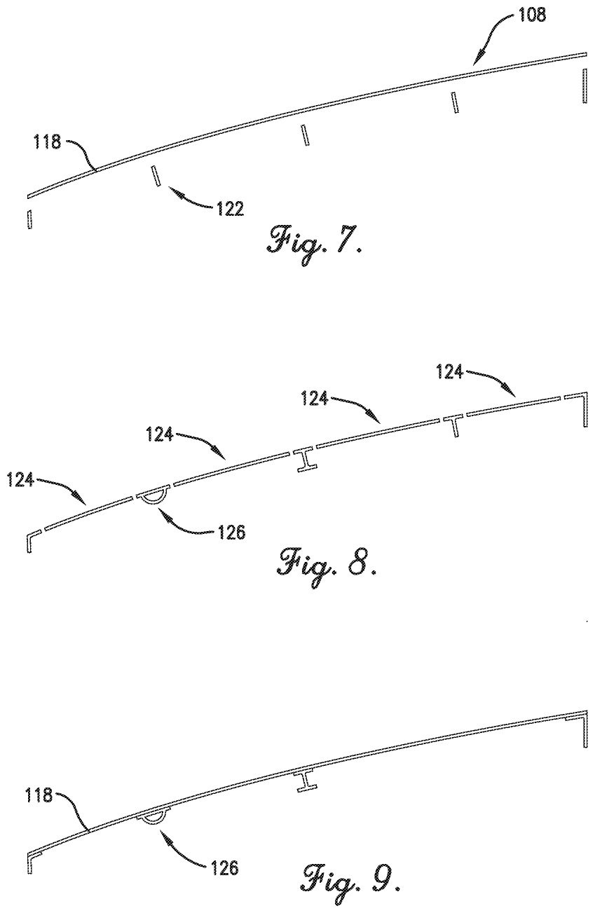

Referring to FIGS. 6-9, in one implementation the shell 118 may be manufactured as a substantially single monolithic piece (seen in FIG. 6), while in another implementation, the shell 118 may be manufactured as a plurality of panels 124 (seen in FIG. 8) having radial and/or circumferential interfaces and which are subsequently joined together to form the shell 118 prior to or simultaneously with the lip-cowl 110 during final integration. As seen in FIG. 6, the monolithic shell 108 may include fully integrated flanges 124 or other features. As seen in FIG. 7, multi-piece integrated manufacturing may include the monolithic shell 118 with separately fabricated and subsequently joined flanges 122 or other features. Joining may use substantially any suitable technology, such as Friction-Stir Welding (FSW), laser welding, or electron beam (e-beam) welding. Stiffeners 112 and/or other features may be added to the shell 108 using substantially any suitable technology, such as additive manufacturing. Stiffeners may include “blade” stiffeners (as illustrated), grid stiffeners (e.g. honeycomb, rectangular, triangular/isogrid), pad-ups, and/or reinforcements around cutouts.

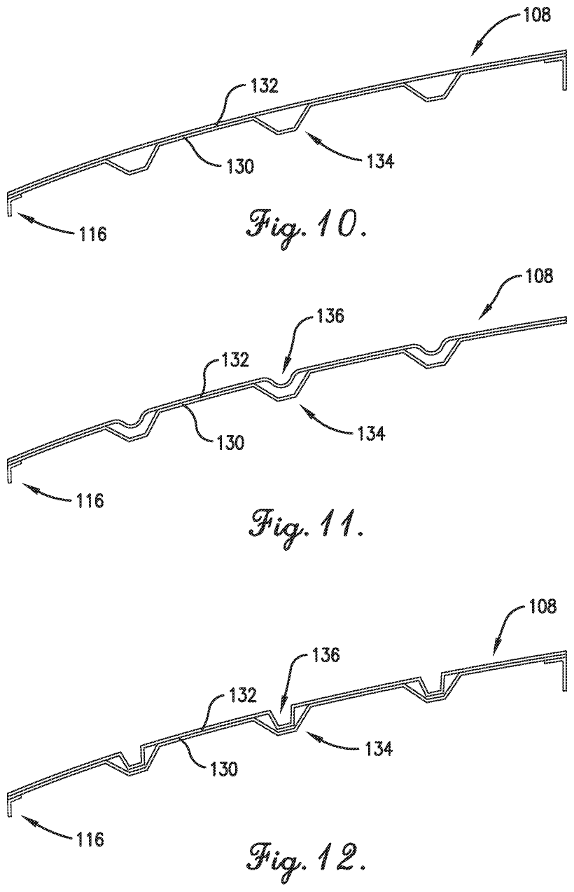

As seen in FIG. 8, multi-piece integration may use multiple formed panels 124 and formed shapes 126 (e.g., angles, tees, zees) to create the shell 108. Joining may include fusion methods such as Friction-Stir Welding (FSW), laser welding, or electron beam (e-beam) welding. Alternatively, as seen in FIG. 9, the formed shapes 126 may be mechanically fastened to the shell 118. This may include drilling and fastening at discrete fastener locations or “fastening” with in-situ fasteners such as Rotary Friction Spot Welding. The shell 118 may be machined after joining to improve the accuracy of the interface to the lip-cowl 110. In one implementation, the panels 124 may be fabricated with excess material on the sides adjacent to the lip-cowl 110, and this interface may be machined following joining to improve the accuracy of the interface. For both implementations, the shell may be manufactured using substantially any suitable technology, such as spin (centrifugal) casting, stretch-forming, machined spin-formed (flow-formed) plate(s), and 3D printed (additive manufacturing) components. “Panelized” construction may use multiple castings with machined interfaces which are subsequently joined. Optionally, after joining, the interface to the lip-cowl 110 may be machined.

Referring to FIGS. 10, 11, and 12, the shell 118 of the framework 108 may include an inner skin 130 and an outer skin 132. The inner and outer skins 130,132 may be joined together using substantially any suitable technology, such as drilling and fastening at discrete fastener locations or “fastening” with in-situ fasteners such as Rotary Friction Spot Welding (RFSW), or adhesive or fusion bonding. The shell 118 may be machined following joining of the inner and outer skins 130,132 to improve the accuracy of the interface to the lip-cowl 110. In various implementations, the inner skin 130 may be formed with integral stiffeners 134 (as seen in FIG. 10); the outer skin 132 may also be formed with integral stiffeners 136 and the outer skin 132 may interface with the inner skin 130 at contours common to the inner surface of the lip-cowl 110 (as seen in FIG. 11); and/or the outer skin 132 may also be formed with integral stiffeners 136 and the outer skin 132 may interface with the inner skin 130 at contours common to the inner surface of the lip-cowl 110 and the stiffeners 136 of the outer skin 132 may interface within respective stiffeners 134 of the inner skin 130 (as seen in FIG. 12). The inner and/or outer stiffeners 134,136 may be empty or filled with a material (e.g., foam) having desired or needed properties.

In one implementation, the framework 108 may be constructed using composite materials and manufacturing processes. With regard to the monolithic shell 118, example composite manufacturing may include Resin Transfer Molding (RTM) braid, knit, and stitched Fibers; compression/Injection molded; blow/vacuum formed sheet molding compounds; co-cured shapes; and AM. With regard to the panels 124 of the panelized shell 118, example composite manufacturing may include co-Bonded laminates; co-cured laminates; compression/Injection molded inner/outer skins bonded or welded together (panel segments); and cellular sandwich panels.

In another implementation, the framework 108 may be constructed using a hybrid approach. Referring again to FIG. 9, the shell 118 may be formed as a metallic component with the separately fabricated composite shapes 126 either mechanically fastened or bonded to the shell 118. A laser or e-beam surface treatment may be used to roughen the metallic shell 118 to improve bonding of co-cured composite shapes 126 directly to the skin 118. Alternatively, the shell 118 may be constructed of composite material and the composite and/or metallic shapes 126 may be mechanically fastened or bonded.

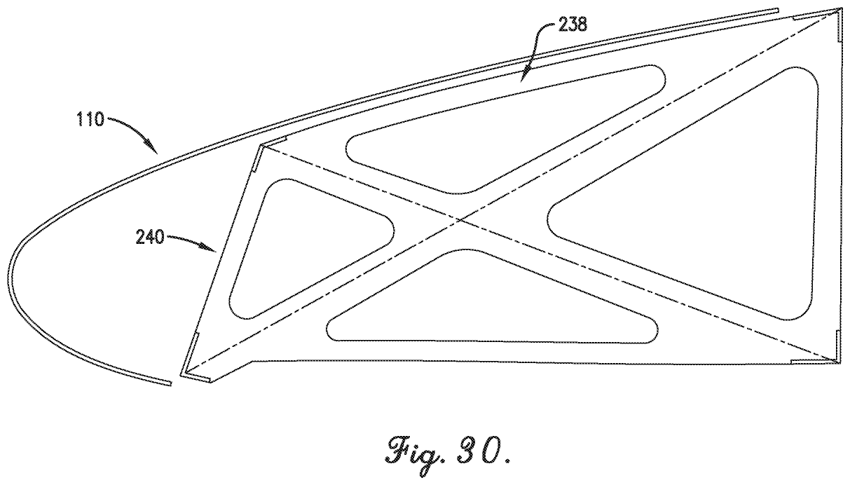

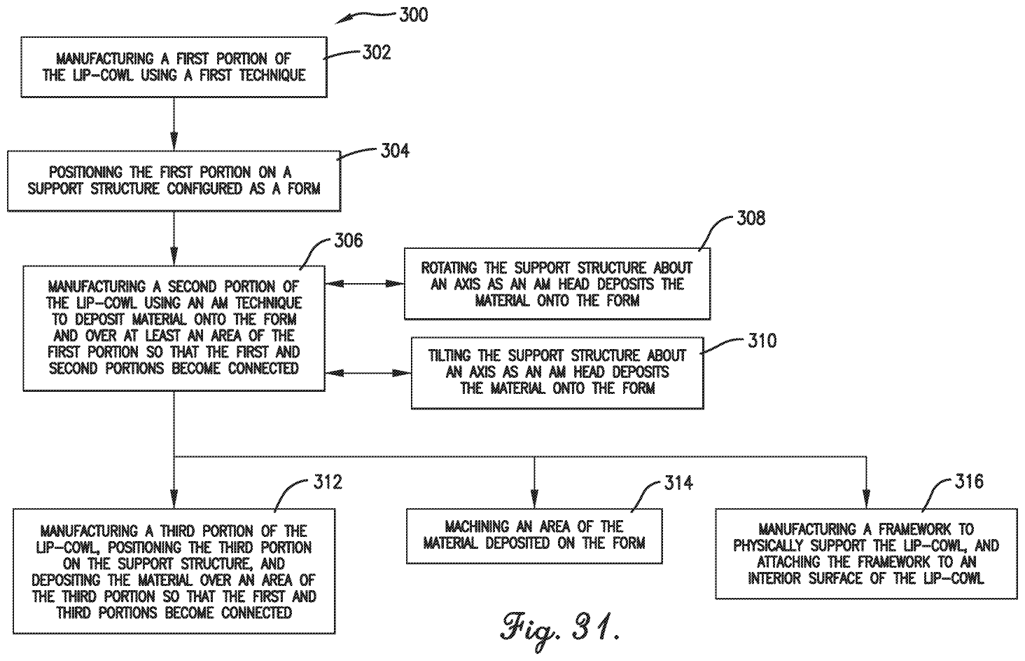

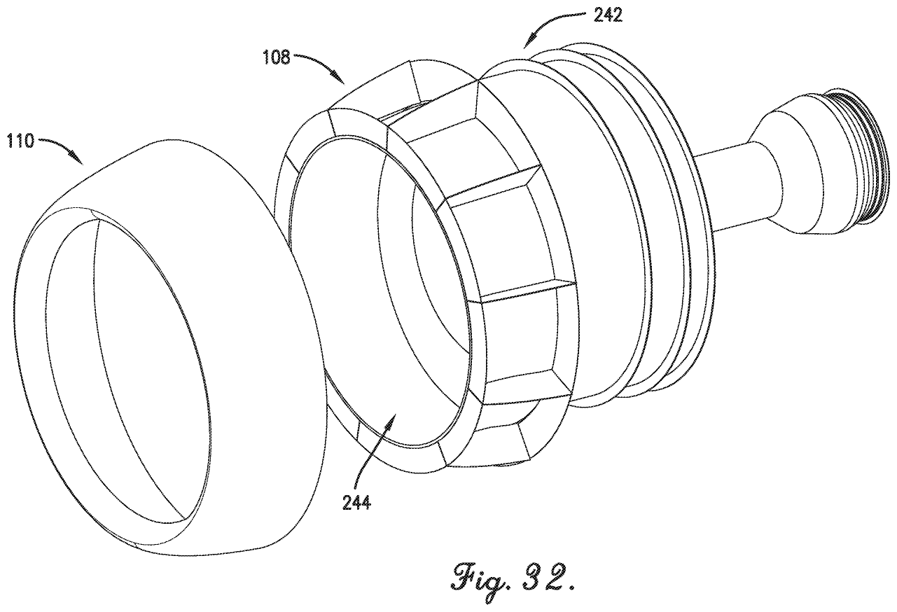

The framework 108 may not be limited to components located near the outer surface of the nacelle inlet. Referring to FIGS. 29 and 30, longitudinal, lateral ribs, and/or diagonal frames or ribs 238,240 of substantial depth may be incorporated as part of the components integration. Bulkheads or other barriers may be incorporated as well. Examples of frame or rib shapes that may be used include cast or machined trusses, assembled stringers or webs, compression/injection molded components, hydro/hammer-formed sheets, Super-Plastic Formed sheets, and additive manufacture components. In one implementation, a three-dimensional space frame (truss) roughly cylindrical in shape may be utilized with previously discussed shapes and methods to produce the framework 108. As with the previously discussed methods of integrating framework components, these “high-relief” frame or rib shapes 238,240 are not limited to orthogonal orientations, and may be incorporated as part of the manufacturing process.

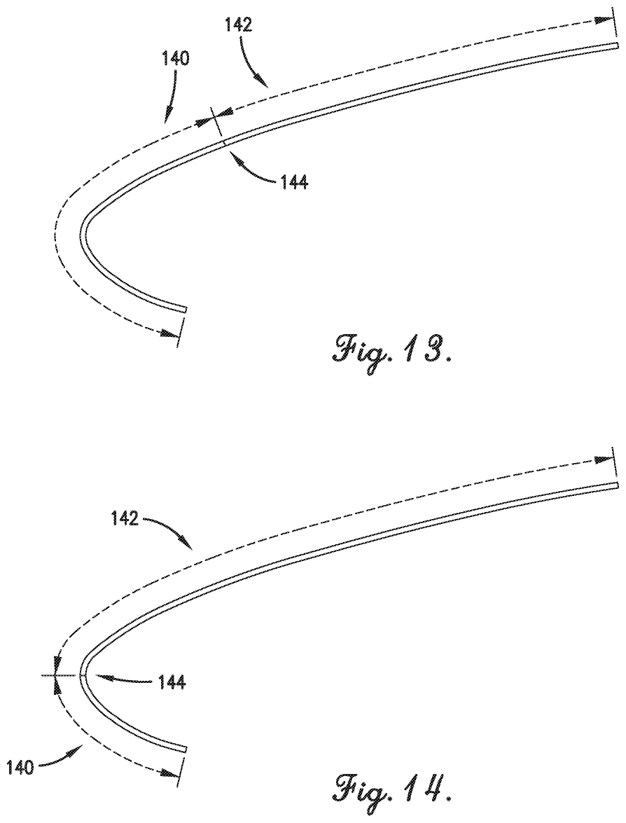

Referring to FIGS. 13 and 14, the lip-cowl 110 may comprise multiple (e.g., fore and aft, as seen in FIG. 13, or inner and outer, as seen in FIG. 14) segments 140,142 which may be joined together at a joint 144. The segments 140,142 may have identical, similar, or different material characteristics. The segments 140,142 may have edges located circumferentially, radially, and/or biased. The joint 144 may be a butt or scarf joint. Various example manufacturing strategies for the lip-cowl 110 include the following:

| | Fore/Inner | Aft/Outer | |
|---|---|---|---|
| Type | Segment(s) | Segments(s) | Joint |
| Metallic | Aluminum <4> <9> | Aluminum <3> <9> | FSW or Fusion |
| | | | <7> <11> |
| Hybrid | Titanium <5> <9> <10> | Aluminum <3> <9> | FSW or Fusion |
| | | | <7> |
| Hybrid | Aluminum <4> <9> | Composite <1> <6> | Bond <8> |
| Hybrid | Titanium <5> <9> <10> | Composite <1> <6> | Bond <8> |
| Hybrid | Composite <2> | Composite <1> <6> | Co-Cure/ |
| | | | Co-Bond |

<1> Solid Laminate geometries or sandwich panel construction
<2> Thermally conductive or embedded heat source construction
<3> Stiffening ribs, grids, lattice may be machined prior to joining
<4> Spun or bulge formed
<5> Hot formed
<6> Stiffening elements may be integrally formed during cure
<7> Joint path may be linear (circumferential), sine-wave, or other shape
<8> Joint may be single or double scarf and may use e-beam or laser roughened metallic surfaces for better composite bond
<9> Additional features may be “3D Printed” onto segments prior to final machining (near net shapes) or post machining (net shapes)
<10> Foil/Sheet laminate diffusion bonded or 3D printed using ultra-sonic welding
<11> Ultra-sonic welding

Such hybrid construction advantageously allows for varied requirements of present and future inlet design architectures and requirements. As desired or needed, the segmentation of the lip-cowl components may be located differently.

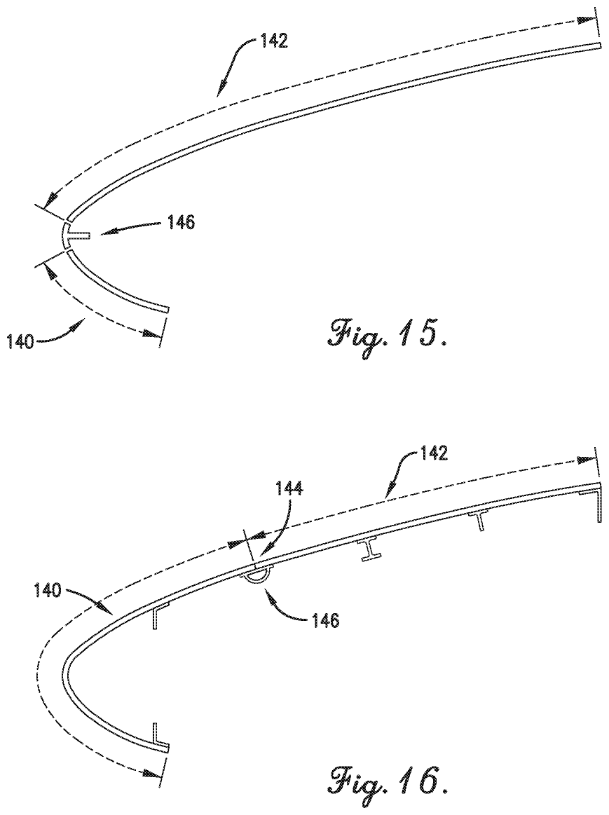

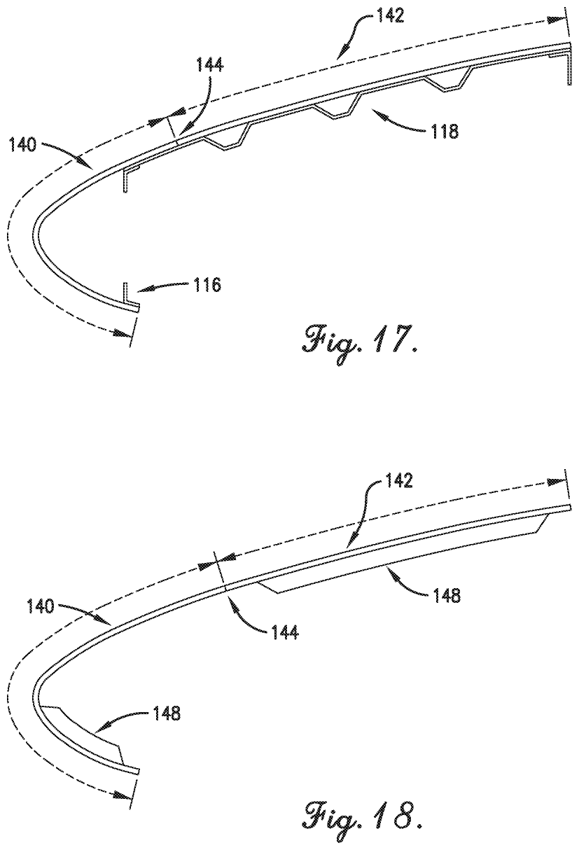

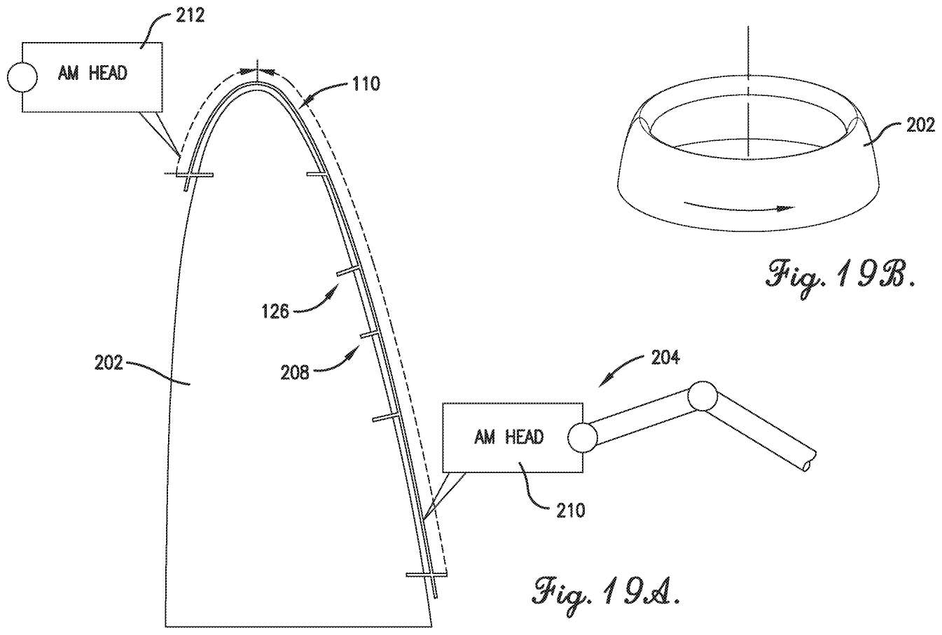

Structural components 146 may be interposed between segments 140,142 of the lip-cowl 110, as seen in FIG. 15. Structural components 146 may be integrated with or attached to the inner surface of the segments 140,142 of the lip-cowl 110, as seen in FIG. 16. The structural components 146 may span the entire or partial circumference of the lip-cowl 110. Components may be oriented longitudinally (i.e., substantially parallel with the engine centerline axis) and/or may frame areas of the lip-cowl 110 to provide localized support. The lip-cowl 110 may be integrated with the shell 118 of the framework 108, as seen in FIG. 17. The lip-cowl 110 may include panels 148, as seen in FIG. 18. The panels 148 may be constructed of substantially any suitable technology such as pre-fabricated honeycomb cellular core or foam with internal lattice structures.

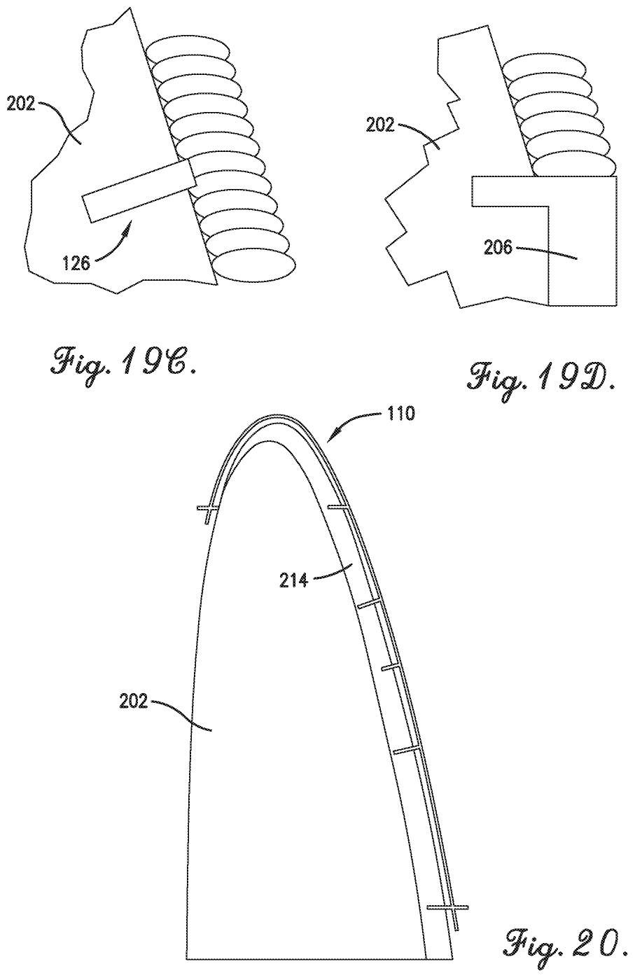

Referring to FIGS. 19A-27B, an embodiment of an AM system 200 is shown for manufacturing the lip-cowl 110. In one implementation, the AM system 200 may employ an “upright” build orientation, while in another implementation, the AM system may employ an “inverted” build orientation. Referring particularly to FIG. 19A, the AM system 200 may include a temporary support structure 202 and one or more AM heads 204.

The support structure 202 may be shaped and otherwise configured to receive added material from the AM heads 204 and form the material into the lip-cowl 110. In one implementation, the support structure 202 may be positioned on a rotatory table or otherwise made rotatable, and as the support structure 202 is rotated (depicted in FIG. 19B), the AM heads 204 may move upward depositing layers of material.

The support structure 202 may include temporary build supports 208 at intermediate location above the shelf 206 to assist in supporting and maintaining the layers on the support structure 202 as they are deposited on the surface of the support structure 202. The temporary build supports 208 may resemble spikes, pegs, toggle-bolts, and/or threaded-bolts, and may be inserted into the support structure 202 and become consolidated with the lip-cowl 110 during the deposition of material to aid in minimizing sagging and distortion and otherwise stabilizing the material. The temporary build supports 208 may be removed prior to the final machining of the lip-cowl 110. The support structure 202 may initially receive or otherwise engage and maintain in proper positions one or more stiffeners and/or other internal features 126 to be integrated with the lip-cowl 110. As the material is deposited by the AM heads 204 over the ends of the internal features 126, the internal features become integrated into the lip-cowl 110, as seen in FIG. 19C. The support structure 202 may include a shelf 206 configured to support an initial layer, or “starter course,” of the deposited material, as seen in FIG. 19D. The shelf may also include additional features such as internal angles 116 and internal features 126.

In one implementation, the support structure 202 may be made of a material, provided with a surface, or coated with a surface treatment resistant to fusing with the melted material being deposited. In another implementation, seen in FIG. 20, the support structure 202 may include a sacrificial layer 214. Certain configurations and contours may result in internal features becoming “trapped” on the support structure 202. The sacrificial layer 214 may include segmented portions that can be removed once the AM process has been completed.

The AM heads 204 may be mounted on moveable arms and computer-controlled to deposit material in upwardly advancing layers onto the support structure 202 as the support structure 202 rotates. In one implementation, there may be a single AM head 210 which is repositionable to deposit material on both outer and inner portions of the support structure 202. In another implementation, there may be an outer AM head 210 for depositing material on the outer surface of the support structure 202 and an inner AM head 212 for depositing material on the inner surface of the support structure 202, with the outer and inner AM heads 210,212 meeting at an apex of the upright support structure 202. In one implementation, the AM heads 204 may be moveable in both radial (y) and vertical (z) axes. The lip-cowl 110 may not be axially symmetric, so the radial (y) movement of the AM heads 204 compensates for the asymmetry as the lip cowl 110 is rotated. The vertical (z) axis movement accommodates the layering of the deposited material.

The AM system 200 and the “upright” build orientation provides a number of advantages, including consolidating pre-fabricated components during the AM process; providing in-process support consolidation; using sacrificial layers to enhance support of, e.g., stiffener elements; and coordinating the movement of the AM heads with the rotation of the support structure to enable asymmetric deposition.

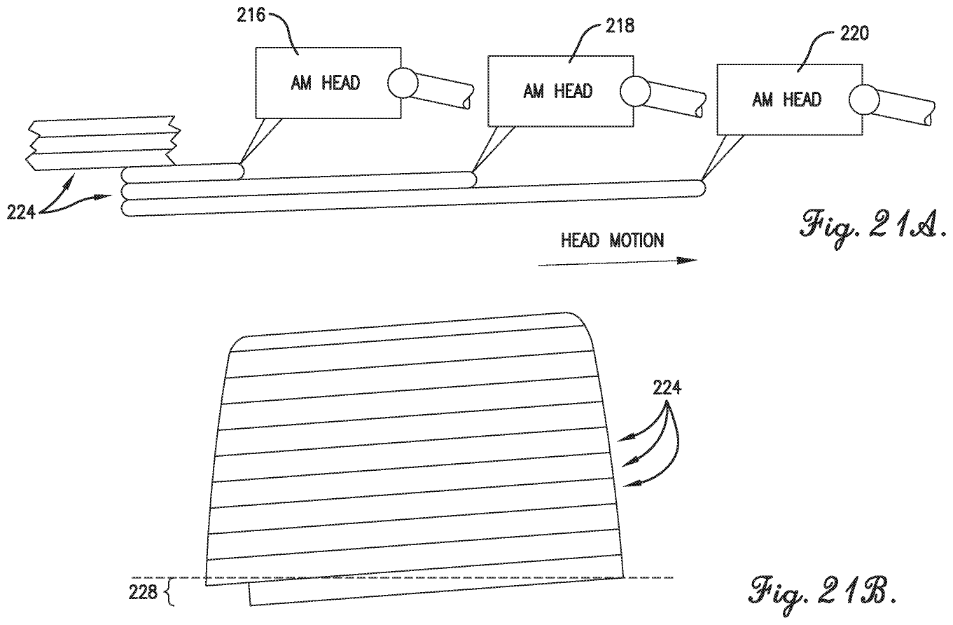

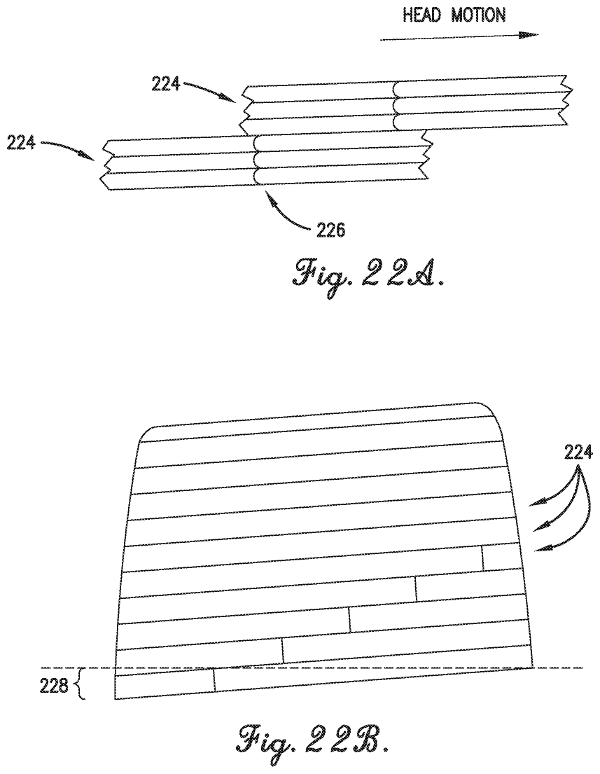

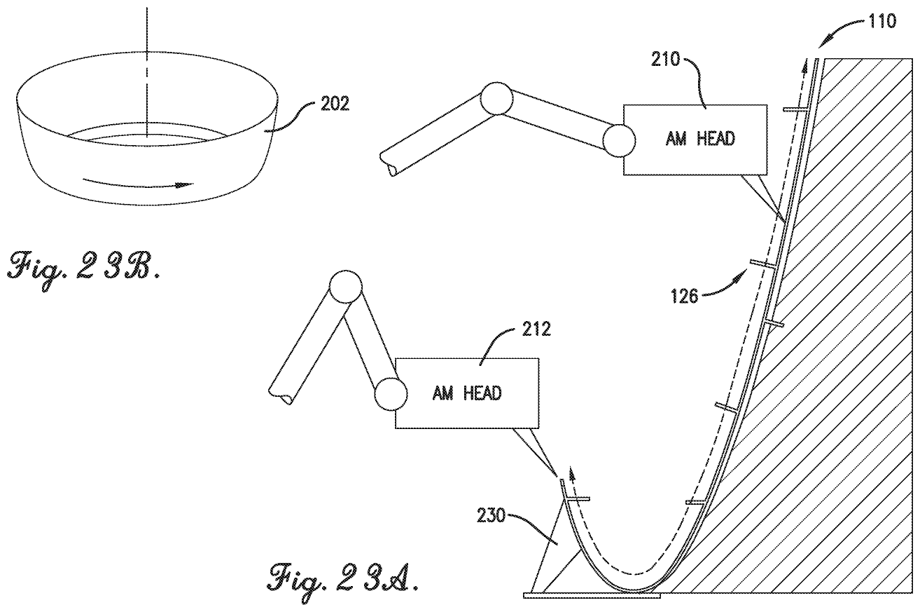

Multiple AM heads 216, 218, 220 may be used to increase rates of material deposition (e.g. pounds/hour, inches/minute), as seen in FIGS. 21A and 21B. Multiple bands 224 of material may be added with each rotation of the support structure 202. In small or high curvature or otherwise “tight” areas, some of the AM heads may temporarily cease operation. For example, multiple AM heads may operate until close to the apex of the part lip-cowl 110, at which point only a single AM head may continue to deposit material around the increased curvature contour of the lip. A shelf may be used for the first band such that the bottom bead laid by the leading AM head smoothly transitions onto the existing band top beam deposited by the trailing AM head during the previous rotation, thereby providing seamless deposition. The banding 224 may be deposited with a ramp angle equal to the lip highlight to facilitate transitioning from the banding operation to operation of a single AM head. In an alternative implementation, the banding 224 may be deposited “head-to-tail,” in which each layer starts and ends at the same location/elevation, as seen in FIGS. 22A and 22B. To continue through the next rotation, the AM heads step up to the top course of the prior band and begin depositing the next layer which similarly ends after 360 degrees rotation. These start/stop seams 226 may be staggered around the build. Once deposition is complete excess material 228 needed to facilitate the additive process may be removed.

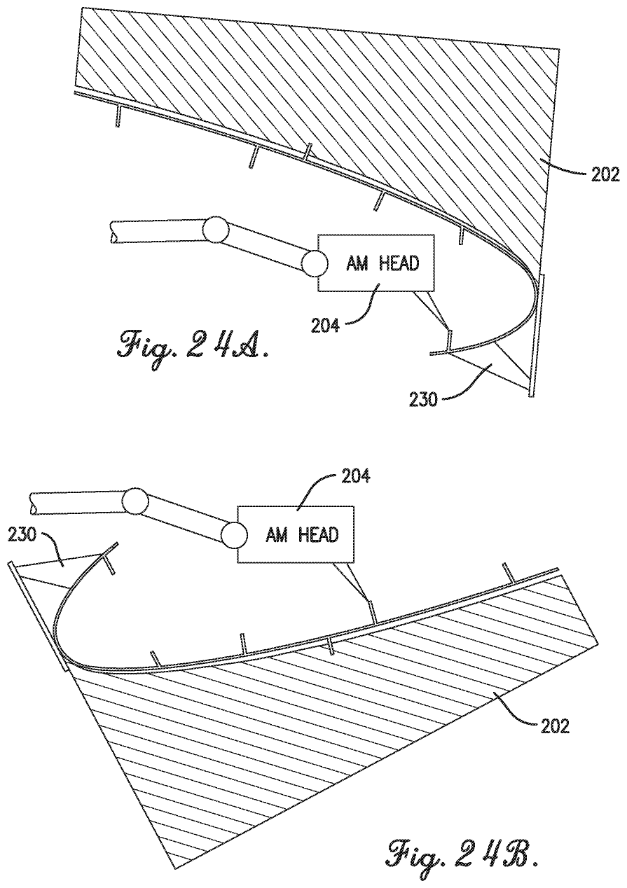

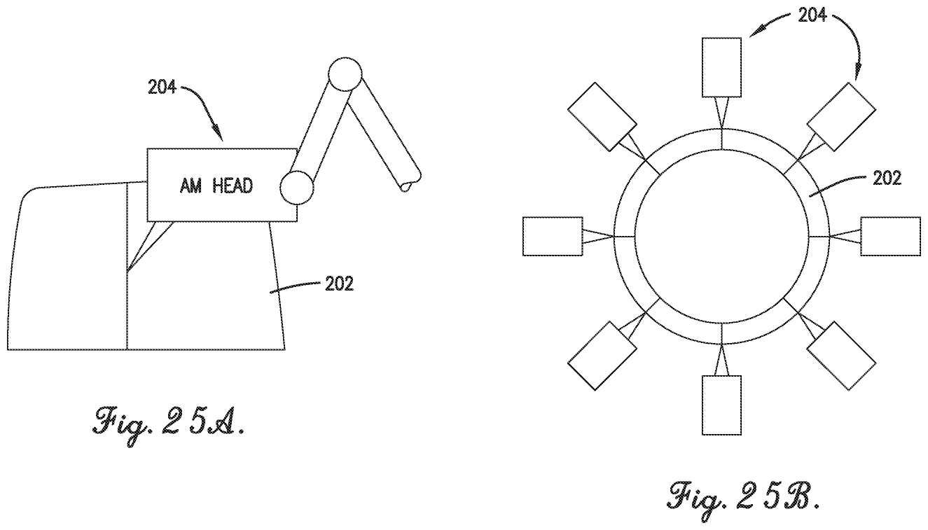

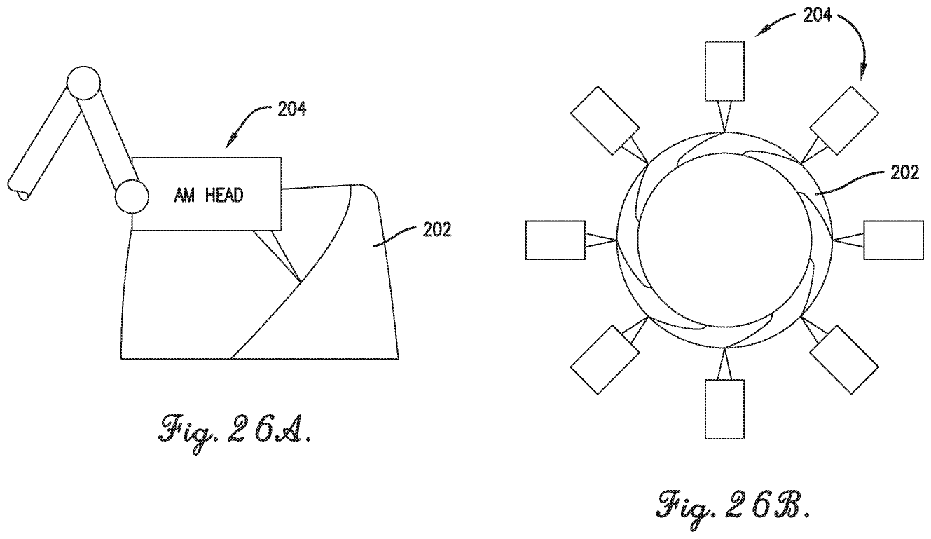

Referring to FIGS. 23A-24B, in another implementation, the lip-cowl 110 may be fabricated using the AM system 200 and an “inverted” build orientation. Building in an inverted orientation may be substantially similar to building in an upright orientation, except as follows. The lip-cowl 110 may be constructed in two operations building upward along the support structure 202 from the “valley” of the support structure 202. The shorter inner portion of the lip-cowl 110 may be deposited in a free-standing (i.e., self-supporting) process. Support scaffolding 230 may be applied as the deposition operation progresses providing stabilization of the developing lip cowl 110. The support scaffolding 230 may take the form of support sections manually or automatically moved into place as the build progresses. This support scaffolding 230 may be sacrificial and built as the deposition progresses. The support structure 230 may be cut or otherwise removed from the finished piece prior to final machining of the lip-cowl 110. The deposition process may be paused allowing the inner surface of the developing lip-cowl 110 to be locally machined to refine interfaces to receive additional features which may be integrated as discussed elsewhere herein. This intermediate step may be beneficial in integrating features using fusion welding or separate additive process, especially if the features may be difficult to access once the deposition process has been completed. Any such integrated features may include excess material so that needed tolerances are achievable with final machining.

Referring particularly to FIGS. 24A and 24B, the AM system 200 configured for the inverted build orientation may include an additional axis for tilting the support structure 202 relative to one or more of the AM heads 210,212 to facilitate positioning the support structure 202 for direct deposition of stiffening and attachment flanges 126. Using the rotation of the support structure 202, stiffeners/flanges 126 may be deposited partially or completely around the lip-cowl component 202. Using these motion degrees-of-freedom, shapes and non-linear paths may be deposited on the interior or exterior, as desired or needed. Examples of such shapes may include a stiffening flange around a cutout area or a boss for attaching equipment or another structural part. Stiffeners oriented longitudinally, or fore-to-aft, may also be deposited.

Thus, the AM system 200 provides several advantages over prior art manufacturing technologies, including allowing for tilting the work-piece to vary the thickness or width of deposition of the bands, and allowing for coordinating movement of the AM head with rotation of the work-piece to achieve asymmetric deposition.

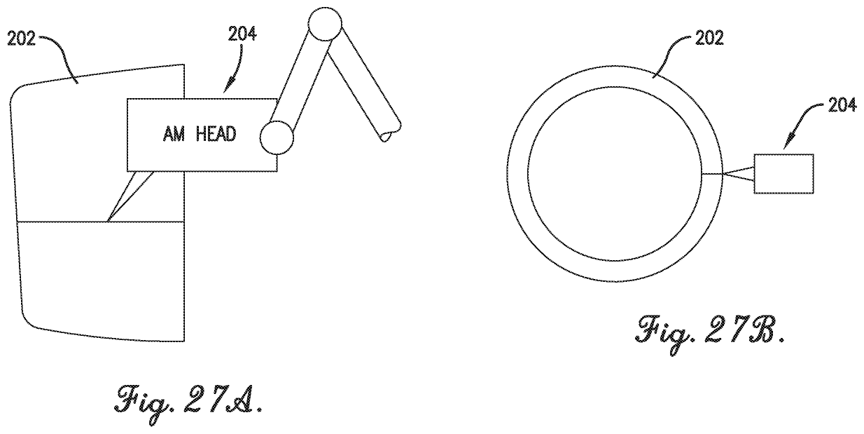

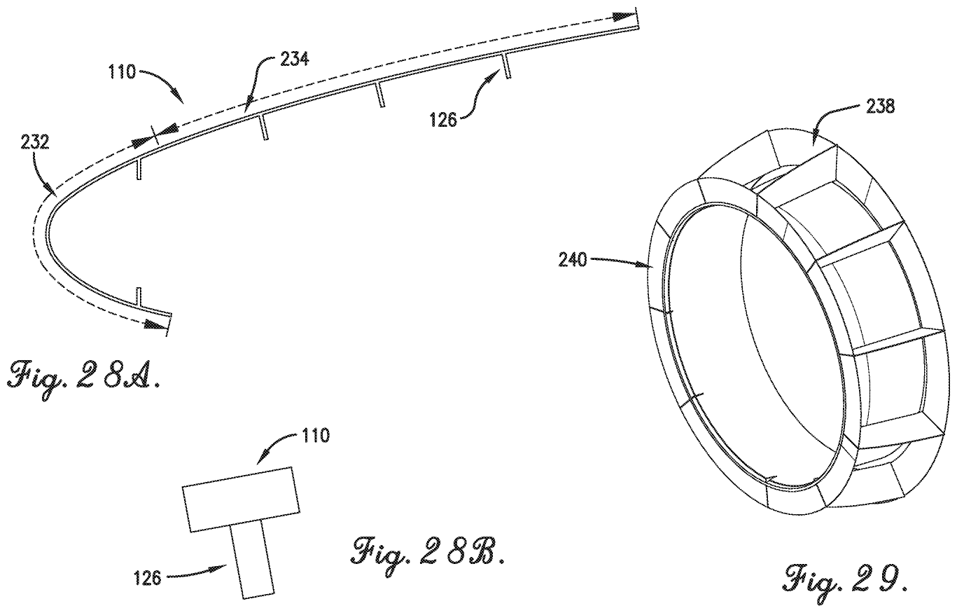

In addition to the “circumferential” deposition paths already described, the AM system 200 may be configured to allow for non-circumferential deposition paths. The one or more AM heads 204 may deposit material vertically on the non-rotating support structure 202, as seen in FIGS. 25A and 25B. Once the vertical path is complete, the support structure 202 may be rotated to the next path index point and the material deposition may continue. Referring to FIGS. 26A and 26B, the one or more AM heads 204 may deposit material diagonally on the rotating support structure 202. In both implementations, multiple AM heads 204 may be used to increase the rate of deposition of the material. The support structure 202 may be oriented and rotated vertically to achieve “stream-wise” deposition, as seen in FIGS. 27A and 27B. Material may be deposited along a horizontal or diagonal path. The material deposition may be unidirectional (e.g. always deposited from an initial point to an ending point then returning to near the initial point and beginning deposition again along a substantially parallel path) or bidirectional (e.g. initial to ending, then continuing deposition from the ending back to near the initial point along a substantially parallel path).

A large area AM technology, such as energy-based deposition processes or during curing for binder-based processes, may be used to build-up layers substantially parallel to the support structure 202 until a desired thickness is achieved. Bands of material may be deposited using single or multiple AM heads 204. Multiple AM heads 204 arranged approximately parallel to each other and spaced apart from the base to the apex of the support structure 202 may be used to deposit a total coverage layer with a single rotation of the support structure 202.

Internal components and temporary build supports may be directly consolidated with energy-based deposition processes or during curing for binder-based processes. The latter may use build supports with “button” heads, or other shapes designed to increase the interface between the support and deposited skin.

The AM system 200 may include both additive and machining (subtractive) equipment to allow for a progressive build, as desired or needed. For example, certain areas may not be accessible once the additive process is complete, so intermediate machining may be performed in these areas. Further, local machining may be used to facilitate additional features created using additive manufacturing.

Alternatively or additionally to the stiffening components and/or integrated shapes/components, other 3D printed components may be integrated during deposition as well. Examples of such 3D printed components may include leading edges with an integral network of passages or embedded electrical systems to provide icing protection; reinforcement or a specialized structure to resist bird-strike penetration; porous external sections enabling airflow boundary layer control through blowing or suction; porous internal airflow sections enabling sound attenuation of engine noise; fittings for support and attachment of the inlet to the nacelle and/or for attaching systems or equipment; transport networks for routing air, fluids, light, radiant energy (e.g. microwaves), and/or electricity; sub-component shapes; an entirely separate framework structure; and any combination thereof.

Once final machining of the lip-cowl is complete, additional features may be added. For example, boundary layer control micro-features (riblets) may be deposited (e.g. blown powder laser deposition) onto the exterior surface of the lip-cowl 110 or features produced by removal or other manipulation of surface material (e.g. electron-beam sculpting, etching). The blown powder method may allow for in-service repairs of riblets by removing the affected area (using, e.g., abrasive) and depositing new material. E-beam sculpting of an affected area may involve re-establishing (through an additive process), refining, prepping, and then re-sculpting a base. Electron beam processes may require use of a vacuum chamber.

Referring to FIGS. 28A and 28B, hybrid material structures may employ specialized constituents in a tailored fashion to enhance local structural performance to the benefit of the overall structure. It will be appreciated that the divide between the substrate and the AM part may be located substantially anywhere on the larger structure, such as further into the curve of the lip zone (as shown in FIG. 14). Thus, for example, the cowl portion could be spin-formed to include more of the lip than is shown in FIG. 28A. The AM system 200 may be configured to allow for incorporating first materials able to withstand higher temperatures in the lip zone 232 of the lip-cowl 110 and for incorporating less costly second materials able to withstand lower temperatures in the cowling or zone 234 while still providing a monolithic part. Further, materials having higher stiffness, or strength, may be strategically deposited to enhance structural performance. For example, metal matrix composites may be deposited to improve the effectiveness of stiffeners 126 integrated into the inner surface of the lip-cowl 110. Referring to FIG. 28B, the stiffener 126 may be constructed from material similar to the lip-cowl near the interface and transition to a stiffer material at the distal end of the stiffener 126 enhancing the structural capability over a stiffener fabricated from a single material.

Materials that are more durable, or damage tolerant, may be deposited around cutouts or in bands where the lip-cowl 110 will be fastened to adjacent structures (e.g., free ends). Materials that are tougher may be deposited in a network, or grid, to limit the propagation of cracks and thereby enhancing damage tolerance of the monolithic structure.

Referring to FIG. 31, an embodiment of a method 300 of manufacturing a hybrid lip-cowl for an inlet of a nacelle may proceed substantially as follows. The method 300 may be configured to manufacture a version of the lip-cowl having one or more of the features described herein, and the method 300 may be implemented by a version of the AM system 200 described herein. In one implementation, the method 300 may result in the lip-cowl 110 including a lip portion or zone 232 and a cowl portion or zone 234 and having an interior surface and an exterior surface.

A first portion (e.g., the cowl portion or zone or some part thereof) of the lip-cowl may be manufactured using a first manufacturing technique, as shown in 302. The first portion may be manufactured from a first material. Depending on the first material, the first manufacturing technique may be a spin-forming technique or a stretch-forming technique. The first portion of the lip-cowl may be positioned on a temporary support structure configured as a form, as shown in 304.

A second portion (e.g., the lip portion or zone of some part thereof) of the lip-cowl may be manufactured using an AM technique to deposit a material onto the form and over at least an area of the first portion of the lip-cowl positioned on the temporary support structure, wherein the material subsequently hardens so that the first and second portions of the lip-cowl are connected, as shown in 306. The second portion may be manufactured from a second material which is the same, similar to, or different from the first material.

The first portion may include a scarf at an interface between the first portion and the second portion so that the connection between the first and second portions includes a scarf joint. Additionally or alternatively, the first portion may include an engagement structure at an interface between the first portion and the second portion so that the connection between the first and second portions includes the engagement structure.

The temporary support structure may be rotatable about a vertical axis, and the method may include rotating the temporary support structure about the vertical axis as an AM head deposits the material onto the form to manufacture the second portion, as shown in 308. Additionally or alternatively, the temporary support structure may be tiltable about a horizontal axis, and the method may include tilting the temporary support structure about the horizontal axis as the AM head deposits the material onto the form to manufacture the second portion, as shown in 310.

In one implementation, the method 300 may include manufacturing a third portion of the lip-cowl, positioning the third portion of the lip-cowl on the form, and manufacturing the second portion of the lip-cowl using the AM technique to deposit the material onto the form and over at least an area of the third portion of the lip-cowl positioned on the form, wherein the material subsequently hardens so that the first and third portions of the lip-cowl are connected, as shown in 312. The third portion of the lip-cowl may be one or more stiffener elements, and/or the third portion may be one or more connection elements positioned at an interface between the first and second portions of the lip-cowl.

In one implementation, the method 300 may include machining an area of the material deposited onto the form by the AM head, as shown in 314. In one implementation, the method 300 may be broadened to manufacture an inlet of a nacelle, wherein the inlet includes the lip-cowl, which may be manufactured as described above, and a framework. The framework may be configured to physically support the annular lip-cowl, and then the framework may be attached to the interior surface of the annular lip-cowl, as shown in 316.

Referring to FIG. 32, in one implementation, the lip-cowl 110 and framework 108 may be separate components, with the framework 108 integrated into an engine fan case 242 with an extended acoustic panel 244. The lip-cowl 110 may be removable or permanently installed.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A method of manufacturing a lip-cowl for an inlet of a nacelle, the lip-cowl including a lip portion and a cowl portion and having an interior surface and an exterior surface, the method comprising:
manufacturing a first portion of the lip-cowl using a first manufacturing technique;
positioning the first portion of the lip-cowl on a temporary support structure configured as a form; and
manufacturing a second portion of the lip-cowl using an additive manufacturing technique to deposit a material onto the form and over at least an area of the first portion of the lip-cowl positioned on the temporary support structure, wherein the material subsequently hardens so that the first and second portions of the lip-cowl are connected.

2. The method of claim 1, the first portion being the cowl portion and the second portion being the lip portion.

3. The method of claim 2, the first manufacturing technique being a spin-forming technique or a stretch-forming technique.

4. The method of claim 1, the first portion including a scarf at an interface between the first portion and the second portion so that the connection between the first and second portions includes a scarf joint.

5. The method of claim 1, the first portion including a connection structure at an interface between the first portion and the second portion so that the connection between the first and second portions includes the connection structure.

6. The method of claim 1, the first portion being manufactured from a different material than the second portion.

7. The method of claim 1, the temporary support structure having an upright orientation with the lip portion located above the cowl portion.

8. The method of claim 1, the temporary support structure having an inverted orientation with the lip portion located below the cowl portion.

9. The method of claim 1, the temporary support structure being rotatable about a vertical axis, and the method further including rotating the temporary support structure about the vertical axis as an additive manufacturing head deposits the material onto the form to manufacture the second portion.

10. The method of claim 1, the temporary support structure being tiltable about a horizontal axis, and the method further including tilting the temporary support structure about the horizontal axis as the additive manufacturing head deposits the material onto the form to manufacture the second portion.

11. The method of claim 1, further including—
manufacturing a third portion of the lip-cowl;
positioning the third portion of the lip-cowl on the form; and
manufacturing the second portion of the lip-cowl using the additive manufacturing technique to deposit the material onto the form and over at least an area of the third portion of the lip-cowl positioned on the form, wherein the material subsequently hardens so that the first and third portions of the lip-cowl are connected.

12. The method of claim 11, the third portion of the lip-cowl being one or more stiffener elements.

13. The method of claim 11, the third portion of the lip-cowl being one or more connection elements positioned at an interface between the first and second portions of the lip-cowl.

14. The method of claim 1, further including machining an area of the material deposited onto the form by the additive manufacturing head.

15. A method of manufacturing an annular lip-cowl for an inlet of a nacelle, the annular lip-cowl including a lip portion and a cowl portion and having an interior surface and an exterior surface, and the annular lip-cowl having no protruding fastener heads and no annularly-extending joints on the exterior surface, the method comprising:
manufacturing a first portion of the annular lip-cowl using a first manufacturing technique;
positioning the first portion of the annular lip-cowl on a temporary support structure configured as a form; and
manufacturing a second portion of the annular lip-cowl using an additive manufacturing technique in which the temporary support structure is rotated about a vertical axis while one or more additive manufacturing head deposits a material onto the form and over at least an area of the first portion of the annular lip-cowl positioned on the temporary support structure, wherein the material subsequently hardens so that the first and second portions of the annular lip-cowl are connected.

16. The method of claim 15, the first portion being manufactured from a different material than the second portion.

17. The method of claim 15, further including—
manufacturing a third portion of the annular lip-cowl;
positioning the third portion of the annular lip-cowl on the form; and
manufacturing the second portion of the annular lip-cowl using the additive manufacturing technique to deposit the material onto the form and over at least an area of the third portion of the annular lip-cowl positioned on the form, wherein the material subsequently hardens so that the first and third portions of the annular lip-cowl are connected.

18. A method of manufacturing an inlet of a nacelle, the method comprising:
manufacturing an annular lip-cowl including a lip portion and a cowl portion and having an interior surface and an exterior surface, and the annular lip-cowl having no protruding fastener heads and no annularly-extending joints on the exterior surface, by—manufacturing a first portion of the annular lip-cowl using a first manufacturing technique,
positioning the first portion of the annular lip-cowl on a temporary support structure configured as a form, and
manufacturing a second portion of the annular lip-cowl using an additive manufacturing technique in which the temporary support structure is rotated about a vertical axis while one or more additive manufacturing head deposits a material onto the form and over at least an area of the first portion of the annular lip-cowl positioned on the temporary support structure, wherein the material subsequently hardens so that the first and second portions of the annular lip-cowl are connected;
manufacturing a framework configured to physically support the annular lip-cowl; and
attaching the framework to the interior surface of the annular lip-cowl.

19. The method of claim 18, the first portion being manufactured from a different material than the second portion.

20. The method of claim 18, further including—
manufacturing a third portion of the annular lip-cowl;
positioning the third portion of the annular lip-cowl on the form; and
manufacturing the second portion of the annular lip-cowl using the additive manufacturing technique to deposit the material onto the form and over at least an area of the third portion of the annular lip-cowl positioned on the form, wherein the material subsequently hardens so that the first and third portions of the annular lip-cowl are connected.
